(19) United States
(12) Patent Application Publication
(10) Pub. No.: US 2014/0136208 A1
(43) Pub. Date: May 15, 2014

(54) SECURE MULTI-MODE COMMUNICATION BETWEEN AGENTS

(71) Applicant: INTERMEC IP CORP., Everett, WA (US)

(72) Inventors: Paul A. Maltseff, Woodinville, WA (US); Roger Byford, Pittsburgh, PA (US)

(73) Assignee: INTERMEC IP CORP., Everett, WA (US)

(21) Appl. No.: 13/677,246

(22) Filed: Nov. 14, 2012

(51) Int. Cl. G10L 13/02

(52) U.S. Cl. CPC G10L 13/02
USPC 704/260

(57) ABSTRACT

A system to assist in secure multi-mode communication is described. The system can receive communications from a source agent in a source communication mode, authenticate the source agent, and determine a recipient communication mode associated with the recipient agent. The system then transforms the communication from the first communication mode to the second communication mode based on the recipient agent and/or the content of the communication and provides the communication to the recipient agent in the recipient communication mode.

### BACKGROUND

In recent years the use of mobile computing applications in the form of human-computer interaction such as mobile communications has become ubiquitous. Mobile computing typically refers to the human-computer interaction by which a computer is expected to be transported during normal usage. The mobile computing applications allow communication between agents or devices in real-time (or near real-time) by way of a single modality or mode of operation. For example, mobile computing applications typically provide for communications by way of an audio (or voice) mode or by way of text messaging mode.

Some mobile computing applications include speech synthesis, which is the artificial production of human speech. A computer system used for this purpose is called a speech synthesizer or a text-to-speech (TTS) system. Similarly, a speech-to-text (STT) system processes speech and converts the speech to text output. TTS systems and STT systems can be implemented in software or hardware. Typical TTS systems convert normal language text into speech or render symbolic linguistic representations like phonetic transcriptions into speech. The synthesized speech can be generated by, for example, concatenating pieces of pre-recorded speech that are stored in a database. The synthesized (or generated) speech can then be provided to a user via a “synthetic” voice output.

At present, current systems do not provide end-to-end solutions for providing verified and authenticated multi-mode communication between agents or devices. For example, a first agent using via a text-based messaging mode cannot effectively communicate with a second agent using a voice-based messaging mode. Further, the current systems do not synthesize and/or otherwise generate customized speech according to a particular individual or source device. Accordingly, the need exists for a system that overcomes the above problems, as well as one that provides additional benefits.

Overall, the examples herein of some prior or related systems and their associated limitations are intended to be illustrative and not exclusive. Other limitations of existing or prior systems will become apparent to those of skill in the art upon reading the following.

### BRIEF DESCRIPTION OF THE DRAWINGS

Examples of end-to-end solutions that can facilitate customized and verified multi-mode communication between agents or devices utilizing mobile computing applications are illustrated in the figures. The examples and figures are illustrative rather than limiting.

FIG. 1 is a block diagram that illustrates an example environment that can facilitate customized and verified multi-mode communication between agents or devices utilizing mobile computing applications.

FIG. 2 is a block diagram that illustrates an example of components in a host server able to provide customized and verified multi-mode communication between agents or devices utilizing mobile computing applications.

FIG. 3 is a block diagram that illustrates an example environment that can provide customized and verified multi-mode communication between agents or devices utilizing mobile computing applications.

FIG. 4 is a block diagram that illustrates an example environment that can provide customized and verified multi-mode communication between agents or devices utilizing mobile computing applications.

FIG. 5 is a flow diagram that illustrates an example process of providing customized and verified multi-mode communication between agents or devices utilizing mobile computing applications.

FIG. 6 is a flow diagram that illustrates an example process of transforming a communication from source mode to recipient mode.

FIG. 7 is a data structure or table that illustrates an example set of entries that can be used by a host system and/or an agent device to select a voice tone associated with a communication between agents or devices utilizing mobile computing applications.

FIG. 8 is a table that illustrates an example of a set of entries that are selected by a host system and/or an agent device to indicate style, urgency, rate, and/or paralinguistic events associated with each of one or more segments of a communication between agents or devices utilizing mobile computing applications.

FIG. 9 is a signaling diagram that illustrates representative messaging used by a source agent to transform communications at a host system.

FIG. 10 is a signaling diagram that illustrates representative messaging used by a source agent and a recipient agent to transform communications at a host system.

FIG. 11 is a signaling diagram that illustrates representative messaging used by a recipient agent to transform communications at a host system.

FIG. 12 is a signaling diagram that illustrates representative messaging used by a recipient agent to transform communications at a host system and at the recipient agent.

FIG. 13 is a signaling diagram that illustrates representative messaging used by a recipient agent to transform communications at the recipient agent with transform files downloaded from the host system.

FIG. 14 is a signaling diagram that illustrates representative messaging used by a source agent to transform communications at the source agent with transform files downloaded from the host system.

### DETAILED DESCRIPTION

A system is described for providing customized and verified multi-mode communication between agents or devices. The communication may be any type of communication that is generated by a source agent and presented to or otherwise made available to a recipient agent, such as a voice call, a video call, an instant messaging session, etc. The agents can concurrently utilize different modes of communication, such as voice-based (or audio) communication, video-based communication, text-based communication, etc. For example, a source agent can communicate with a recipient agent via a text-based communication mode while the recipient agent concurrently communicates with the source agent via a voice-based communication mode.

In order to provide the appropriate communication to a recipient, the multi-mode communication is transformed into the appropriate mode for the recipient agent. For example, a communication may need to be transformed from text to audio or from audio to text. Speech synthesis may be used to perform the text to audio transformation. The speech synthesis systems disclosed herein provide naturalness and intelligibility of a generated voice. The systems can be adjusted to meet particular requirements such as speech utterance.

Additionally, in some embodiments, the systems synthesize and/or otherwise generate or provide customized speech according to a particular individual or user of a source device. The customized speech may be generated to reflect particular styles. For example, speech communication can be thought of as comprising two channels—the words themselves, and the style in which the words are spoken. Each of these two channels carries information. A single, fixed style of delivery, independent of the message does not reflect substantial information attributed to the context of the message. For example, urgency and/or level of importance of a communication or message is not typically provided when generating a voice utilizing a single, fixed style. However, as disclosed herein, any number of speaking/declaration styles can be used to convey the communication. In addition, the system may generate various paralinguistic events such as confident voice, sighs, pauses, etc., which further enrich and personalize the generated communication.

The generated (or synthesized) speech may provide a level of confidence to a recipient agent as to the identity of the particular individual or user of the source device. The systems and methods disclosed herein may incorporate steganography within the communications or data streams in order to provide for additional security in some embodiments. For example, hidden messages can be incorporated into the multi-mode communications or data streams. The hidden messages can be used by recipient agents and/or other systems to confirm the authenticity and/or the identity of a source agent. The creation of stealthy channels for voice over Internet Protocol (VoIP) can be used based on the exploitation of free or unused fields of communication protocols such as Internet Protocol (IP), UDP, TCP, Real-Time control Protocol (RTCP), etc. These protocols utilize header fields that may be free and/or padding fields that may be unused. In some embodiments, it is possible to alternatively or additionally use encryption algorithms to secure the communications.

Various examples or implementations of the invention will now be described. The following description provides specific details for a thorough understanding and enabling description of these examples. One skilled in the relevant art will understand, however, that the invention may be practiced without many of these details. Likewise, one skilled in the relevant art will also understand that the invention may include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

### Representative System

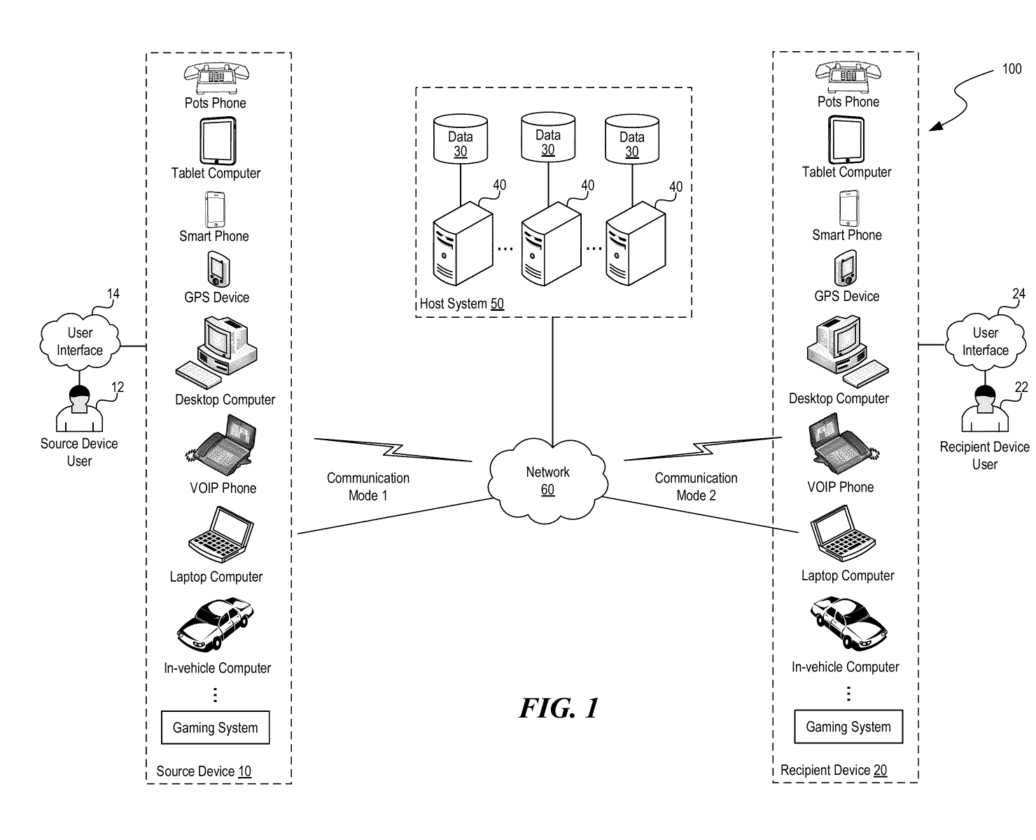

FIG. 1 is a block diagram that illustrates an example environment 100 that can facilitate customized, verified, multi-mode communication between agents or devices utilizing mobile computing applications, according to one embodiment. In this example, the environment 100 includes a source device 10, a recipient device 20, a host system 50, and a telecommunications network 60. FIG. 1 is intended to provide a general overview of an environment 100 where embodiments of the disclosed technology may be implemented.

The environment 100 facilitates customized communication between the source agent and the recipient agent via different modes of operation. For example, a source agent can communicate with a recipient agent via a text-based communication mode while the recipient agent concurrently communicates with the source agent via a voice-based communication mode. As shown in FIG. 1, the host system 50 includes multiple servers 40 and data repositories 30. It is appreciated that any number of servers 40 and/or data repositories 30 may be included with host system 50.

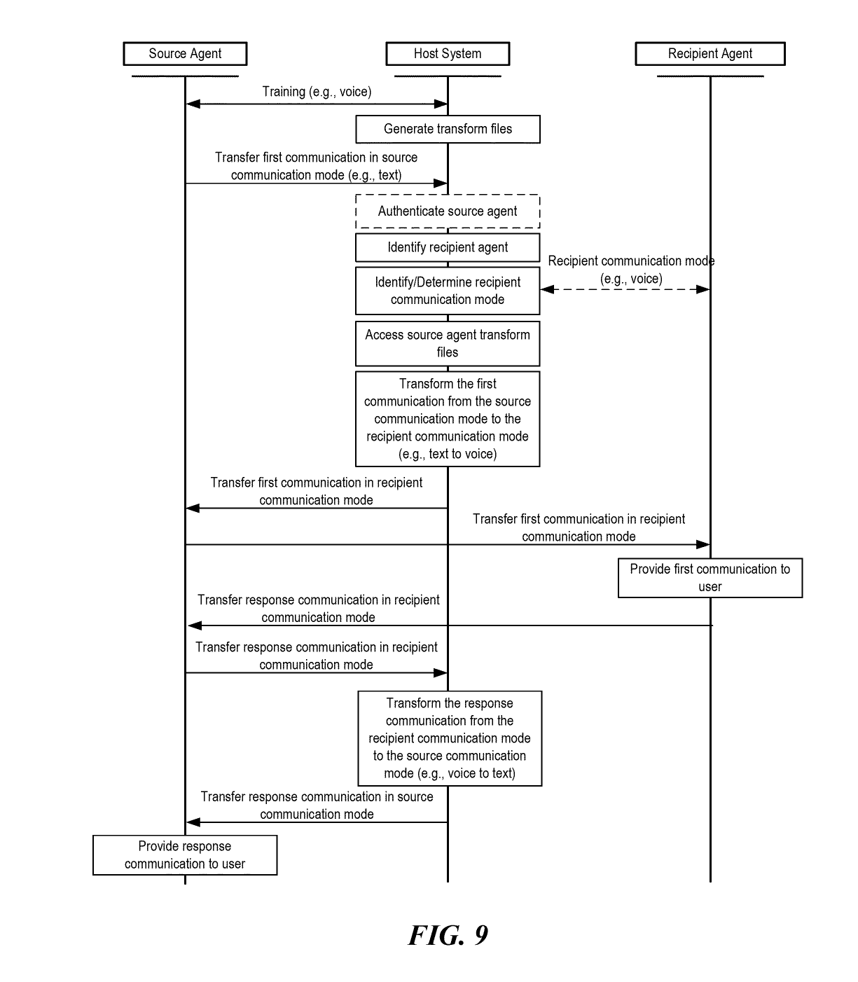

The example environment 100 provides for authentication of the agents and/or transformation of the communications between the agents. Elements of the authentication and/or transformation, or the authentication and/or transformation in their entirety, may be performed by the source agent 10, the recipient agent 20, and/or the host system 50. Accordingly, in some embodiments, the host system 50 is configured to communicate with the source agent 10 and/or the recipient agent 20 in order to perform the authentication and/or the transformation. Representative examples of the various signaling diagrams associated with the authentication and/or transformation at the source agent, the host system, and/or a recipient agent are discussed in greater detail with reference to FIGS. 9-14.

In one embodiment, prior to the source agent 10 exchanging communications with the recipient agent 20, the host system 50 interacts with a source agent 10 to facilitate voice training. The voice training may include one or more templates (or training sequences) and/or various learning or neural network systems. The voice training templates may be stored within one or more of the multiple servers 40 and data repositories 30. However, in some embodiments, it is appreciated that a voice training software package may also be downloaded to the source agent 10. In this case, the voice training software package is executed from the source agent 10.

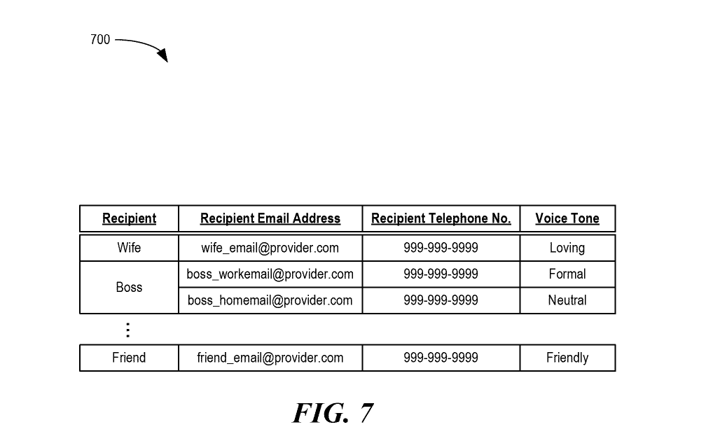

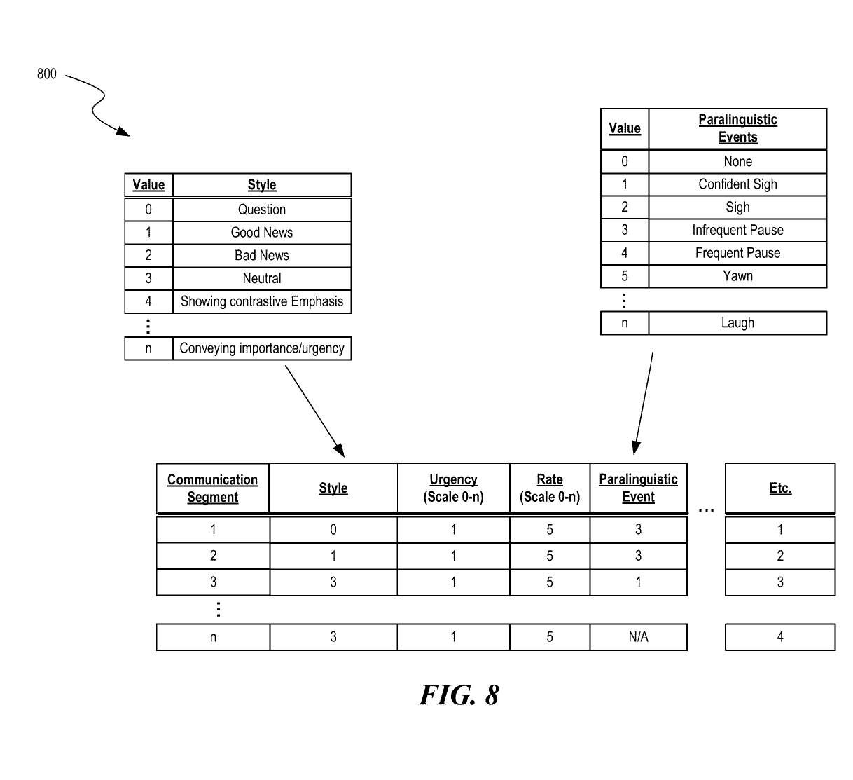

In one embodiment, training sequences may be provided to the source agent 10 so that the host system can learn or otherwise ascertain various aspects of the source user's voice and language usage patterns such as, for example, the various tones and paralinguistic events that a source user typically utilizes in verbal communications with others. The tones and/or paralinguistic events, among other aspects of the source user's voice, can be stored by the host system for later use in the custom voice synthesis. Learning and storing the various aspects of the source user's voice for generating a synthesized version of the user's voice is discussed in greater detail with reference to FIG. 7 and FIG. 8.

The source agent 10 and the recipient agent 20 can be any systems and/or devices, and/or any combination of devices/systems that are able to establish a connection, including wired, wireless, cellular connections with another agent or device, server, and/or other systems such as host system 50. The source agent 10 and the recipient agent 20 will typically include a display and/or other output functionalities to present information (i.e., communications) and data exchanged between among the agents 10 and 20 and/or the host system 50.

The source agent 10 and the recipient agent 20 can include mobile, hand held or portable devices or non-portable devices and can be any of, but not limited to, plain old telephone systems (POTS phones), global positioning system (GPS) devices, Voice over Internet Protocol (VoIP) phones, in-vehicle computers, vehicle tracking systems, server desktops, computer clusters, gaming systems, or portable devices including, notebook computers, laptop computers, handheld computers, palmtop computers, mobile phones, cell phones, smart phones, PDAs, Blackberry devices, Treo devices, handheld tablets (e.g. an iPad, a Galaxy, Xoom Tablet, etc.), tablet PCs, thin-client devices, hand held consoles, hand held gaming devices or consoles, iPhones, and/or any other portable, mobile, hand held devices, etc. running on any platform or any operating system (e.g., Mac-based OS (OS X, iOS, etc.), Windows-based OS (Windows Mobile, Windows 7, etc.), Android, Blackberry OS, Embedded Linux platforms, Palm OS, or Symbian platform.

As shown, the source agent 10 and the recipient agent 20 include respective user interfaces 14 and 24. The user interfaces 14 and 24 may be used by source device user 12 and recipient device user 22 to interact with the source agent 10 and the recipient agent 20, respectively. The source agent 10 and the recipient agent 20 can also include various input mechanisms (not shown). For example, the input mechanisms can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), and/or combinations or variations of the above.

The telecommunication network 60 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

The network 60 can be any collection of distinct networks operating wholly or partially in conjunction to provide connectivity to the host system 50 and agents (e.g., source agent 10 and recipient agent 20). In one embodiment, communications to and from the agents and/or to and from the host system 50 can be achieved by, an open network, such as the Internet, or a private network, such as an intranet and/or the extranet.

The agents and host system 50 can be coupled to the network 60 (e.g., Internet) via a dial-up connection, a digital subscriber loop (DSL, ADSL), cable modem, wireless connections, and/or other types of connection. Thus, the agents can communicate with remote servers (e.g., the host system 50, etc.) that provide access to user interfaces of the World Wide Web via a web browser, for example.

The databases 30 can be implemented via object-oriented technology and/or via text files, and can be managed by a distributed database management system, an object-oriented database management system (OODBMS) (e.g., ConceptBase, FastDB Main Memory Database Management System, JDOlnstruments, ObjectDB, etc.), an object-relational database management system (ORDBMS) (e.g., Informix, OpenLink Virtuoso, VMDS, etc.), a file system, and/or any other convenient or known database management package. As shown, the databases 30 are coupled to (or otherwise included within host server 50). However, it is appreciated that in some embodiments, the databases 30 may be alternatively or additionally directly coupled to network 60 and/or distributed across multiple systems.

In some embodiments, a set of data or a profile related to an agent may be stored in the databases 30. The profile may include associated transformation files for customized transformation of communications from one communications mode to another as described herein and/or specific language usage patterns for particular users. An example of the type of information that may be stored in databases 30 is illustrated and discussed in greater detail with reference to FIG. 7 and FIG. 8.

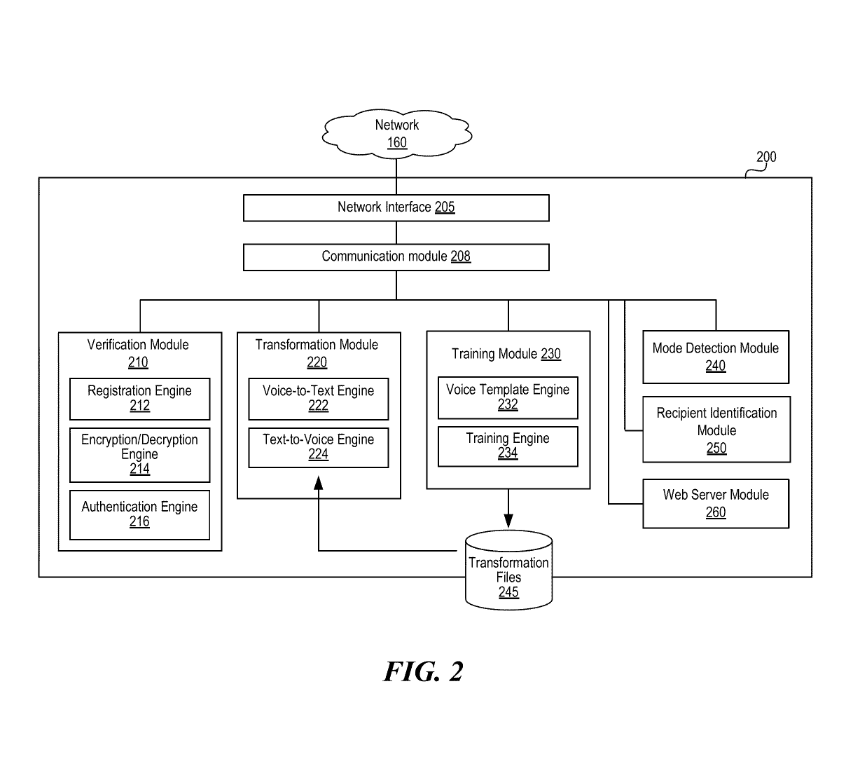

FIG. 2 is a block diagram that illustrates an example of components in a host system 200 able to facilitate customized and verified multi-mode communication between agents or devices. The host system 200 may be the host system 50 of FIG. 1, although alternative configurations are possible. In the example of FIG. 2, the host system 200 is communicatively coupled to a transformation files database 245 and a network 160. The transformation files database 245 may be the database 30 of FIG. 1 and the network 160 may be the network 60 of FIG. 1, although alternative configurations are possible.

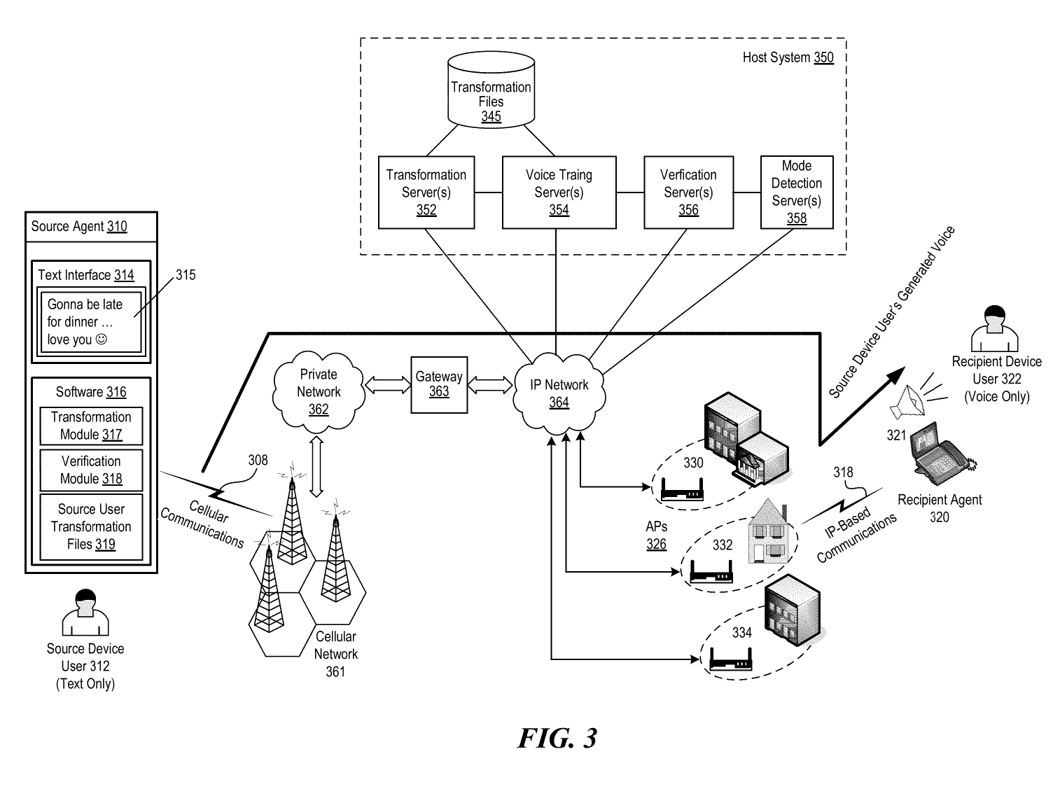

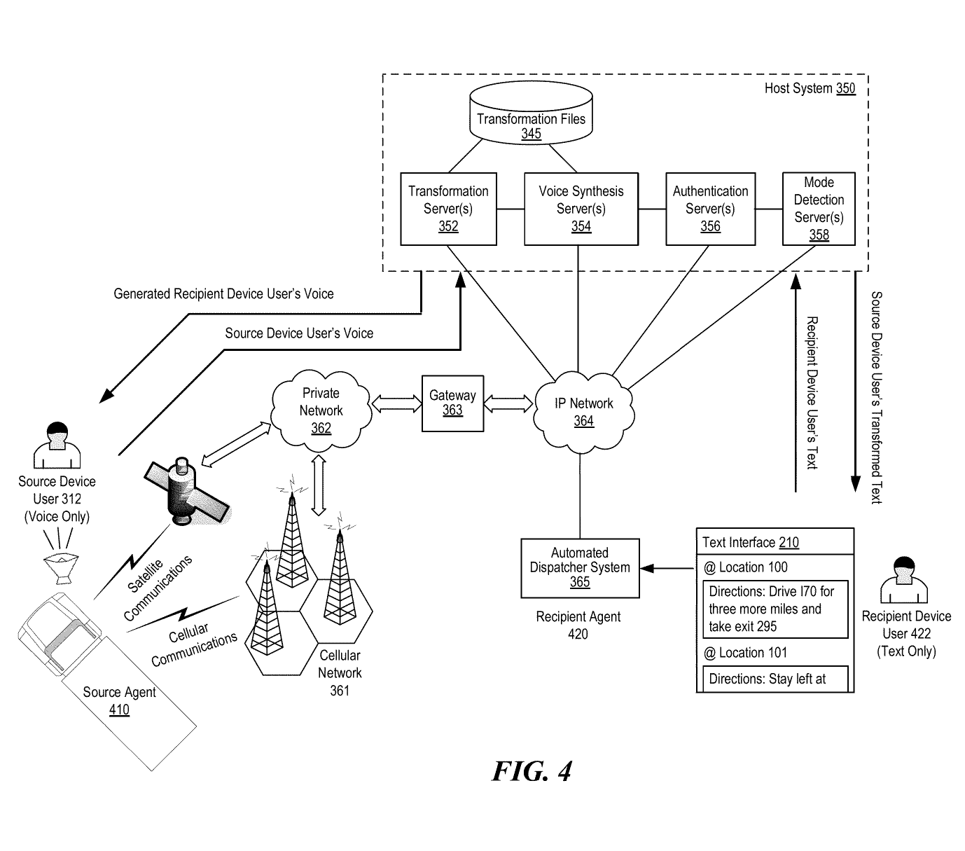

The host system 200, although illustrated as comprised of distributed components (physically distributed and/or functionally distributed), could be implemented as a collective element. In some embodiments, some or all of the modules, and/or the functions represented by each of the modules can be combined in any convenient or known manner. Moreover, the functions represented by the modules can be implemented individually or in any combination thereof, partially or wholly, in hardware, software, or a combination of hardware and software. It is appreciated that some or all of the host system 200 modules described with respect to FIG. 2 may be included, alternatively or additionally, in whole or in part, in the host system 350 of FIG. 3 or 450 of FIG. 4. Furthermore, in some embodiments, some or all of the host system 200 modules described with respect to FIG. 2 may be included, alternatively or additionally, in whole or in part, within a source device or destination device. In one embodiment, some or all of the host system 200 modules are embodied in a software application “app” that is downloaded or otherwise transferred to the source agent and/or the recipient agent.

In the example of FIG. 2, the host system 200 includes a network interface 205, a communication module 208, a verification module 210, a transformation module 220, a voice training module 230, a communication mode detection module 240, a recipient identification module 250, and a web server module 260. Additional or fewer modules can be included. As shown, the transformation files database 245 is partially or wholly internal to the host server 140. However, the transformation files database 245 can alternatively or additionally be coupled to the host server 200 over network 160. Additionally, in one or more embodiments, the transformation files database 245 can be distributed across and/or replicated to, in whole or in part, one or both of the source agent and the recipient agent. For example, during voice training transformation files may be generated by the host system 200. The transformation files may be periodically and/or otherwise downloaded to or retrieved by a source device or destination device.

In the example of FIG. 2, the network interface 205 can be one or more networking devices that enable the host server 140 to mediate data in a network with an entity that is external to the server, through any known and/or convenient communications protocol supported by the host and the external entity. The network interface 205 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

In the example of FIG. 2, the host server 200 includes the communications module 208 communicatively coupled to the network interface 205 to manage one or more communication sessions over multiple communications protocols. The communications module 208 receives data (e.g., audio data, textual data, audio files, etc.), information, commands, requests (e.g., text, video, and/or audio-based), and/or text-based messages over a network. Since the communications module 208 is typically compatible with receiving and/or interpreting data originating from various communication protocols, the communications module 208 is able to establish parallel and/or serial communication sessions with agents.

One embodiment of the host server 200 includes the verification module 210. The verification module 210 can be any combination of software agents and/or hardware components able to manage, authenticate users (e.g., agents) and/or communications, and/or register users associated with host server 200. In this example, the verification module 210 includes a registration engine 212, an encryption/decryption engine 214, and an authentication engine 216. Additional or fewer engines are possible.

The registration engine 212 is configured to register new agents (and/or agent device users) with the system and/or create new accounts with the host server 200. During registration the user can provide login credentials, etc. The registration engine 212 is configured to register the agents that attempt to interact with the host server 200. In some embodiments, registration engine 212 also verifies agents attempting to login to the host system by associating a user's username and password with an existing user account. Unauthorized agents can be directed to register with the host system 200.

The encryption/decryption engine 214 is configured to encrypt and/or decrypt communications or aid agents in the encryption/decryption process. Encryption can provide an additional level of security. For example, a communication from a source agent that is registered with the host system may be received and encrypted by the encryption/decryption engine 214. Alternatively or additionally, the host system 200 may aid a source device in the encryption process at the source device. In either case, the encrypted communication is subsequently transferred to a recipient agent where it is decrypted. In some cases, the encryption/decryption engine 214 may aid the recipient device in decrypting the communication.

The authentication engine 216 authenticates communications between agents to ensure that the communications are verified and/or otherwise secure. The authentication may be used in lieu of or in addition to encryption. The authentication engine 216 may make use of stealthy channels (e.g., steganography) by utilizing and/or exploiting free or unused fields of communication protocols such as, for example, Internet Protocol (IP), UDP, TCP, Real-Time Control Protocol (RCP), etc. Other protocols are also possible. By way of example, a global unique identifier (GUID) or other type of digital signature or certificate may be appended somewhere in the file (e.g., within the free or unused fields or elsewhere in the file). The digital certificate could be a fingerprint identifying the source or the recipient agent or could be a random or pseudo random sequence.

Alternatively or additionally, identification codes may be used for specific recipient agents that can be changed or modified in accordance with an algorithm. The identification codes may represent a unique signature or fingerprint. As discussed, the use of steganography can include incorporation of hidden messages in data streams (or communications) between agents. Accordingly, the agents may subsequently confirm or reject the identity of the other party in real-time (or near-real time). This provides additional security for agents.

The use of security and/or the type of security utilized by the agents and/or the host system can be based on the specific communication scenario. For example, some communications may be marked by an agent or a host system as containing sensitive information. These communications may utilize the highest levels of security including authentication and/or the encryption described herein. Alternatively, other communications may be relatively unimportant and thus not include encryption or authentication.

The Secure Sockets Layer (SSL) and/or voice tunneling protocols may be utilized for communications between agents and/or between an agent and the host system. SSL is the standard security technology for establishing an encrypted link between a web server and a browser. This link ensures that all data passed between the web server and browsers remain private and integral. SSL is an industry standard and is used by millions of websites in the protection of their online transactions with their customers.

One embodiment of the host server 200 includes the transformation module 220. The transformation module 220 can be any combination of software agents and/or hardware components able to transform and/or otherwise convert communications from one mode to another mode. In this example, the transformation module 220 includes a voice-to-text engine 222 and a text-to-voice engine 224 (e.g., voice synthesis engine). Additional or fewer engines are possible.

The voice-to-text engine 222 is configured to convert voice-based communications to text-based communications. For example, the voice-to-text engine 222 may access voice-to-text transformation files in the transformation files database 245. The voice-to-text engine 222 may process the content of the voice communication to identify an appropriate tone for the generated text-based communication. The tone and/or other aspects of the voice-based communication or paralinguistic events included in the voice-based communication may be used to determine special characters, shorthand, emoticons, etc., that might be used and included in a generated text-based communication.

The appropriate tone for a generated text-based communication may be based on the tone of the voice communication and/or other aspects or paralinguistic events embedded in the voice communication. Alternatively or additionally, the appropriate tone for the generated text-based communication may be based on the recipient user (or recipient agent). For example, if the recipient user is determined or otherwise identified to be a “friend” of the source user, then the selected tone of the text message may be a friendly tone. In addition, the voice-to-text engine 222 may be more inclined to use shorthand, slang, emoticons, etc. Alternatively, if the recipient user is determined to be the source user's boss, then the selected tone may be more formal. In this case, the voice-to-text engine 222 may be less inclined to use shorthand, slang, emoticons, etc. The voice-to-text engine 222 is configured to transform or otherwise convert communications from a voice-based communication mode to a text-based communication mode. The voice-to-text engine 222 may provide automatic voice recognition and transformation into one or more text files. The text file(s) can be, for example, one or more SMS messages intended for a recipient agent. Alternatively or additionally, the text file(s) may be used to generate SMS messages for a recipient agent.

The text-to-voice engine 224 (voice synthesizer) is configured to convert text-based communications to voice-based communications. In particular, the text-to-voice engine 224 is configured to synthesize, replicate and/or otherwise generate mechanical or customized speech according to a particular individual or agent user. For example, the text-to-voice engine 224 may access voice-to-text transformation files associated with a particular user in the transformation files database 245 in order to synthesize and/or otherwise generate the customized voice communications according to a particular individual or user of a source device.

The customized speech may be generated to reflect particular styles. For example, speech communication can be though of as comprising two channels—the words themselves, and the style in which the words are spoken. Each of these two channels carries information. A single, fixed style of delivery, independent of the message does not reflect substantial information attributed to the context of the message. For example, urgency and/or level of importance of a communication or message is not typically provided when generating a voice utilizing a single, fixed style. However, as disclosed herein, any number of speaking/declaration styles can be used to convey the communication. In addition, the system may generate various paralinguistic events such as confident voice, sighs, pauses, etc., which further enrich and personalize the generated communication.

One embodiment of the host server 200 includes the voice training module 230. The voice training module 230 can be any combination of software agents and/or hardware components able to learn, track, train, and/or otherwise capture an agent user's voice including learning, tracking, and/or otherwise capturing segments of a user's voice, tendencies during communications, traits, and/or other voice characteristics of an agent user. In this example, the training module 230 includes a voice template engine 232 and a training engine 234. Additional or fewer engines are possible.

The voice template engine 232 is configured to provide various voice templates or training sequences to a source agent and/or a recipient agent in order to facilitate voice training for use with the generation of customized speech for particular individuals or agent users.

The training engine 234 facilitates training and capture of a particular agent user's voices. For example, the training engine 234 may utilize a training period and tune the acoustical files to match the voice of a particular speaker. This process may be facilitated through the use of the training sequences provided by the voice template engine 232. In one example, the training engine 234 learns, tracks, trains, and/or otherwise captures voice segments that are received or from the user's voice and/or synthesized based on the particular user's voice. The voice segments may be received in response to the training sequence and/or during tracking of other conversions. The transformation files are subsequently stored in the database 245 and later used by the voice-to-text engine 222 and the text-to-voice engine 224 to generate text-based communications and synthesize the user's voice for voice-based communications, respectively.

One embodiment of the host server 200 includes a mode detection module 240. The mode detection module 240 can be any combination of software agents and/or hardware components able to automatically detect the communication mode of a source device and/or a recipient device. For example, the mode detection module 240 may be in communication with a source agent and/or a recipient agent that keep the mode detection module 240 apprised of their respective current preferred modes of communication. Alternatively or additionally, the mode detection module 240 may automatically detect the mode of communication based on conditions and/or preferences previously setup by the user, historical observations, locations of the user, etc.

One embodiment of the host server 200 includes a recipient identification module 250. The recipient identification module 250 can be any combination of software agents and/or hardware components able to identify the recipient of a communication. The recipient identification module 250 identifies a recipient based on information provided in the communication such as, for example, the recipient email address, telephone number, etc.

One embodiment of the host server 200 includes a web server module 260. The web server module 260 can be any combination of software agents and/or hardware components able to interact with the agents that have logged in or otherwise accessed or interacted with the host server 200. The web server module 260 provides access to agents via a web interface, and may interact with a browser (e.g. as a browser plugin).

FIGS. 3 and 4 are block diagrams illustrating example environments 300 and 400, respectively. In the example environments 300 and 400 the same reference numbers are used to identify elements or acts with the same or similar structure or functionality.

Referring first to FIG. 3, which illustrates the example environment 300 that can facilitate customized and verified multi-mode communication between a source agent 310 and a recipient agent 320. In particular, the example of FIG. 3 illustrates a source agent 310 operating in a text-based communication mode sending a communication for delivery to a recipient agent 320 operating in a voice-based communication mode. In this example, the source agent 310 comprises any mobile device capable of sending a text-based communication (e.g., an SMS message) via cellular communications 308. Similarly, the recipient agent 320 comprises any wired or wireless device capable of receiving voice-based communications (or audio files) over IP-based communications 318. The source agent 310 and the recipient agent 320 may be the source agent 10 and recipient agent 20 of FIG. 1, although alternative configurations are possible.

In the example of FIG. 3, the source agent 310 includes a text interface 314 and software 316. The software may include various software modules and/or transformation data which can be stored on one or more memory systems included within the source agent 310. Alternatively or additionally, the various software modules and/or transformation data may be stored, in whole or in part, in the cloud (e.g., somewhere within the host system 350).

As shown, the software 316 includes a transformation module 317, a verification module 318, and downloaded transformation files 319. The transformation module 317 may individually or in combination with the one or more transformation server(s) 352 transform the text-based communication from the text-based source mode to the voice-based recipient mode. The functionality of the transformation module 317 may be similar to the functionality of transformation module 220 of FIG. 2, although alternative configurations are possible. Further, although the transformation server(s) 352, the voice training server(s) 354, and/or the authentication server(s) 356 are shown included entirely within the host system 350, the functionality of any of these servers may be included or downloaded to one or more of the agents (e.g., the source agent 310 and/or the recipient agent 320).

The network environment 300 includes a cellular network 361, a private network 362, one or more gateways 363, an IP network 364, a host system 350, and one or more access points 326. The cellular network 361, private network 362, and IP network 364 can be any telephony core networks as generally defined by 3GPP and 3GPP2 standards and organizations based on IETF Internet protocols. The networks 361-364 may be together the network 60 of FIG. 1, although alternative configurations are possible. For example, the networks 361-364 may be any kind of wired or wireless networks, such as 2G, 3G, 4G, WiFi, WiMax, etc. or other types of Circuit-Switched (CS) or Packet-Switched (PS) networks. The networks 361-364 can include elements to facilitate communication between various source and recipient agents or devices. The network environment 300 depicted in FIG. 3 has been simplified for purposes of highlighting the disclosed technology, and one skilled in the art will appreciate that additional or fewer components may be utilized.

As shown in the example of FIG. 3, the host system 350 includes various servers that reside in the “cloud.” The various servers are communicatively coupled to the IP network 364 and each other (either directly or through the IP network 364). The various servers can include one or more transformation servers 352, one or more voice training servers 354, and/or one or more verification servers 356. As discussed, the host system 350 may be the host system 50 of FIG. 1 or the host system 200 of FIG. 2, although alternative configurations are possible. In addition, the functionality provided by the transformation server(s) 352, the voice training server(s) 354, and the verification server(s) 356 may be similar to the functionality provided by the transformation 220, the voice training module 230, and the verification module 210, respectively; although other configurations are possible.

According to various aspects of this invention, the source agent 310 and the recipient agent 320 can be configured to operate in a variety of communication modes. For example, if the source device user 312 is in a meeting, then the user can set the source agent 310 to operate in a text-only communication mode. Similarly, the recipient agent 320 can be configured to operate in a voice-only communication mode (e.g., a “hands free” mode) if the recipient device user 322 is unable to communicate via text-based communications. In some cases, the source agent 310 and or the recipient agent manually set a mode of communication. In other cases, the mode of communication may be detected by the agent or the host system (e.g., the mode detection server(s) 358). The detection may be based on any number of factors including environmental factors. For example, if the recipient agent device 320 detects that the recipient device user is moving (e.g., driving, etc.), then the recipient agent device 320 may automatically set the recipient communication mode to a voice-only communication mode. Alternatively, the mode of communication of an agent may be fixed based on the type of agent. For example, an in-vehicle agent or a VoIP phone may be voice only agents in some embodiments.

In another example, an agent can detect the mode of communication based on environmental factors, configuration settings, historical data, and/or other factors. For example, an in-vehicle computer agent can be configured to be operated in a (fixed) voice-only communication mode when in motion and either a text-based communication mode or a voice-based communication mode when stationary (or when the engine is off).

In the example of FIG. 3, a source device user 312 interacts with a touch screen or other input mechanism of the source device 310 in order to input a text communication or message. In this case, the source device user 312 inputs the text message: “Gonna be late for dinner . . . love you [symbol] .” The source device user 312 may be, for example, a husband sending a text-based communication to his wife, the recipient device user 322. In this example, the recipient device user 322 is operating a recipient agent 320 in a voice-based communication mode. In particular, in the example of FIG. 3, the recipient agent 320 is a VoIP phone that cannot communicate via text-based messages.

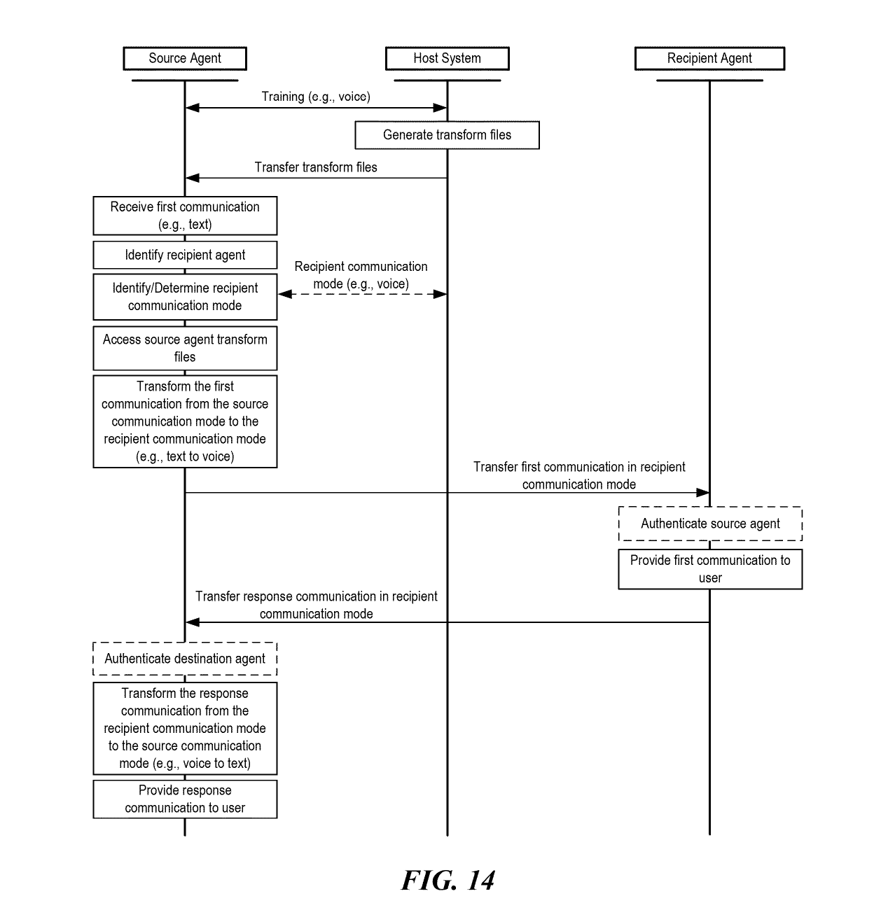

In one example of operation, the transformation from the text-based communication mode to the voice-based communication mode is performed at the source agent device by the source agent device. In this example, the source agent is configured to transmit the voice communication (or voice file) for delivery to the recipient agent 320. An example illustrating representative messaging used by a source agent to transform communications at the source agent with transform files downloaded from the host system is shown and discussed in greater detail with reference to FIG. 14.

In another example of operation, the transformation from the text-based communication mode to the voice-based communication mode is performed in the cloud by the host system 350. In this example, the host system is configured to transmit the voice communication (or voice file) back to the source agent 310 for delivery to the recipient agent 320. Alternatively, the host system may transmit the voice communication for delivery to the recipient agent 320 directly (e.g., without sending the voice communication back to the source agent 310). Examples illustrating representative messaging used by a host system to transform communications in the cloud are shown and discussed in greater detail with reference to FIGS. 9-12.

The transformation server(s) 352 and/or the transformation module 317 may, individually or in combination, transform the text-based communication to a voice-based communication using the transformation files 345 and/or the source transformation files 319. The transformation from the text-based communication to the voice-based communication may include selecting an appropriate tone based on the recipient. For example, the recipient user may be the wife of the source user and thus a “loving” tone for the synthesized voice communication is selected. Selection of a tone during the transformation process is discussed in greater detail with reference to FIG. 7.

Various other parameters may be selected such as style, urgency, rate, paralinguistic events, etc. For example, the “ . . . ” as illustrated in text message 315 may be converted to a long pause by the transformation server(s) 352 and/or the transformation module 317. Additionally, the “ [symbol] ” character may be used by the transformation server(s) 352 and/or the transformation module 317 to select a style (e.g., “good mood”). The various other parameters that may be utilized in the transformation of the text-based communication to a voice-based communication are discussed in greater detail with reference to FIG. 8.

Referring now to FIG. 4, which illustrates another example environment 400 that can facilitate customized and verified multi-mode communication between a source agent 410 and a recipient agent 420. In particular, the example of FIG. 4 illustrates a communication session that is established between a source agent 410 and a recipient agent 420. The source agent 410 and the recipient agent 420 may be the source agent 10 and the recipient agent 20 of FIG. 1, although alternative configurations are possible.

In the example of FIG. 4, the source agent user 412 (e.g., a truck driver) can communicate via source agent 410 (e.g., an in-vehicle computer system) with a recipient agent 420 using a voice-based communication mode. According to the example, the host system 350 performs the authentication and transformation of the communications, although alternative configurations are possible. An example illustrating representative messaging used by the host system to authenticate and transform communications is shown and discussed in greater detail with reference to FIG. 9.

In one example of operation, the recipient agent user 422 inputs instructions into a text interface 210. The instructions are fed into or otherwise input into an automated dispatcher system 365. The instructions or text-based communications are subsequently transferred to the host system 350 where they are transformed into a voice based communication. The voice that is mechanically generated or synthesized may be the voice of the recipient agent user 422. Receiving the voice of the recipient agent user 422 at the source agent 410 may provide a level of comfort to the source agent user 412. Additionally, any instructions can be provided to the source agent user 412 via voice communications allowing the source agent user 412 to continue to maintain attention to the act of driving the truck. System Functions and Data Structures

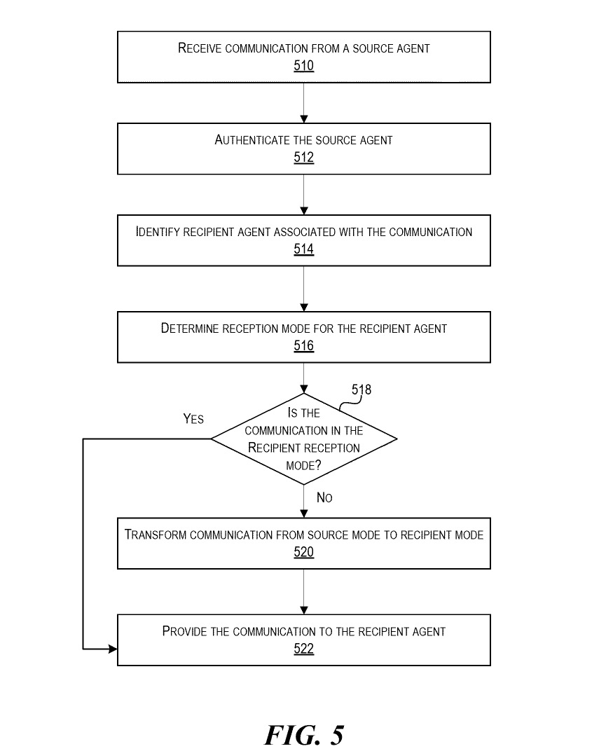

FIG. 5 is a flow diagram that illustrates an example process 500 for facilitating customized multi-mode communication between agents or devices utilizing mobile computing applications. A host system, and/or a source agent, and/or a recipient agent can individually, or in combination, facilitate the customized multi-mode communication between agents. The host system, source agent, and recipient agent can be the host system 50, the source agent 10, and the recipient agent 20 of FIG. 1, respectively, although alternative configurations are possible.

The example of FIG. 5 is described with respect to performance by a host system; however, as discussed above, the source agent and/or the recipient agent may also, individually or in combination with the host system, perform one or more of the steps described below. It is appreciated that the example process 500 described herein does not imply a fixed order for performing the steps. Embodiments may be practiced in any order that is practicable. Furthermore, in some embodiments steps may be omitted or additional steps may be included.

In a receiving stage, at step 510, the host system receives a communication from a source agent such as, for example, source agent 10 of FIG. 1. For example, the host system may receive a communication that originates from a source agent operating in a text-based communication mode. The communication may be received in a particular communication protocol.

In an authentication stage, at step 512, the host system authenticates the source agent. The host system may authenticate the source agent to confirm that the communication is legitimate. As discussed above, the host system may authenticate the source agent using one or more free or unused fields of the communication protocol. For example, the communication protocol may be IP, UDP, TCP, RTCP, etc.

In an identification stage, at step 514, the host system identifies the recipient agent. The recipient agent may be identified based on any number of characteristics of the communication. For example, the recipient agent may be identified based on information contained within the communication such as, for example, the recipient email address, the recipient telephone number, etc. In a determination stage, at step 516, the host system determines the appropriate reception mode (i.e., the recipient reception mode) for the recipient agent.

In a determination stage, at step 518, the host system automatically determines if the communication is in the recipient reception mode. If so, then the host system delivers, transfers, transmits or otherwise provides the communication to the recipient agent (step 522). However, if the host system determines that the communication is not in the recipient reception mode, then in a transformation stage, at step 520, the host system transforms the communication from a source transmit mode to the recipient reception mode before providing the communication.

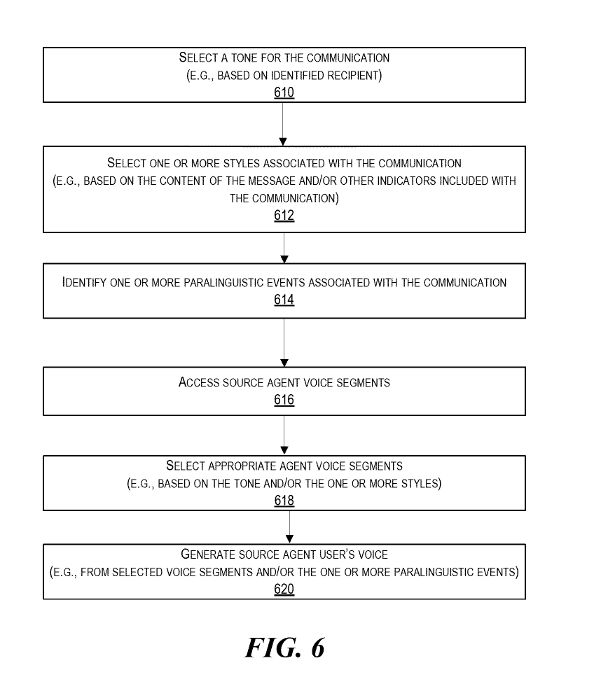

FIG. 6 is a flow diagram that illustrates an example process 600 of transforming a communication from source mode to recipient mode such as, for example, a text-based communication mode to a voice-based communication mode. A host system, and/or a source agent, and/or a recipient agent can individually, or in combination, perform the transformation. The host system, source agent, and recipient agent can be the host system 50, the source agent 10, and the recipient agent 20 of FIG. 1, respectively, although alternative configurations are possible.

The example of FIG. 6 is described with respect to performance by a host system; however, as discussed above, the source agent and/or the recipient agent may also, individually or in combination with the host system, perform one or more of the steps described below. It is appreciated that the example process 600 described herein does not imply a fixed order for performing the steps. Embodiments may be practiced in any order that is practicable. Furthermore, in some embodiments steps may be omitted or additional steps may be included.

In a selection stage, at step 610, the host system selects a tone for the communication. A tone for the communication may be selected based on the recipient agent and/or the source agent. For example, if the source agent user is attempting to communicate with a friend then a “friendly” tone may be selected. Conversely, if the source agent user is attempting to communicate with his or her boss, then a “formal” tone may be selected. Selection of the various tones for a communication is discussed in greater detail with respect to table 700 of FIG. 7.

In a selection stage, at step 612, the host system selects one or more styles associated with the communication. The one or more styles may be selected based on the content of the message and/or other indicators included within the communication. For example, styles may be selected based on specific keywords or phrases that are identified in a text-based communication or special characters such as emoticons. The styles that may be selected can be used to generate the unique voice for the recipient. The styles may include, but are not limited to, a question style, good/bad news style, neutral or no style, a style for showing contrastive emphasis, a style for conveying importance or urgency, etc. As discussed above, the various tones and/or styles can be developed using training sequences and/or built by the neural network system over time. Selection of the various styles for a communication is discussed in greater detail with respect to table 700 of FIG. 7.

In an identification stage, at step 614, the host system identifies one or more appropriate paralinguistic events to utilize in connection with the communication. For example, a long sigh may be selected or otherwise identified in connection with a text-based communication including the phrase “ . . . ”. Identification of the various paralinguistic events for use with a communication is discussed in greater detail with respect to table 700 of FIG. 7.

In an access stage, at step 616, the host system accesses source agent voice segments. In a selection stage, at step 618, the host system selects the appropriate agent voice segments in order to synthesize or otherwise generated the unique voice. The selection of the voice segments may be based on the tone and/or the one or more selected styles.

Lastly, in a generation stage, at step 620, the host system generates a source agent user's voice. The source agent user's voice may be generated using the various selected voice segments and/or the one or more paralinguistic events. For example, as shown in FIG. 8, each of the selected communication segments may have different tone, style, and/or various other factors. The communication segments can be concatenated or otherwise combined to generate the communication. Additionally, in one or more embodiments, the one or more identified paralinguistic events can be appended to the communication segment in order to generate a more customized, realistic synthesized voice.

FIG. 7 is a data structure or table that illustrates an example set of entries that can be used by a host system and/or an agent device to select a voice tone associated with a communication between agents or devices utilizing mobile computing applications.

In the example of FIG. 7, each possible recipient includes one or more associated identifiers such as, for example, an email address, a telephone number, etc. Additionally, each recipient has an associated voice tone. The host system and/or an agent device may receive or otherwise identify a recipient identifier and subsequently select a voice tone associated with the recipient. The source agent user may select voice tones to use with individuals prior to the communications commencing or may determine one or more default voice tones to use with individuals that are not yet associated with a particular voice tone. Alternatively or additionally, in some instances a source agent can override or otherwise select a different or more appropriate voice tone for an individual communication.

FIG. 8 depicts a table 800 that illustrates an example of a set of entries that are selected by a host system and/or an agent device to indicate style, urgency, rate, and/or paralinguistic events associated with each of one or more segments of a communication between agents or devices utilizing mobile computing applications.

In the example of FIG. 8, a text-based communication from a source agent user is transformed into a voice-based communication for a recipient agent user. As previously discussed, the transformation can include breaking or otherwise dividing the communication up into various segments and selecting the appropriate voice segments from the database. Each segment may be a word, phrase, sentence, etc. Additionally, according to the example of FIG. 8, the system can select style, urgency, rate, paralinguistic events, etc. to append or otherwise integrate with the communication segment. The selections can be made to enrich and personalize the generated voice-based communication. Once the appropriate selections have been made, the communication segments are concatenated together or otherwise combined into a voice-based communications that represent a synthesized personalized voice of the source agent user who sent the text-based communication.

### Signaling Diagrams

FIGS. 9-14 depict various example signaling diagrams that illustrate representative messaging used by a source agent, a recipient agent, and a host system to facilitate verified multi-mode communication between agents or devices as described herein. It is appreciated that the various examples are representative rather than limiting.

The following signaling diagrams are discussed with respect to transformation a text-based communication to a voice-based communication. However, the systems and methods described herein are not limited to transforming text-based communications to voice-based communications. It is appreciated that various other modes of communication may be transformed. The diagrams of FIGS. 9-14 are generally self-explanatory based on the above detailed description, but some details will now be provided.

FIG. 9 depicts a signaling diagram that illustrates representative messaging used to facilitate customized and verified multi-mode communication between a source agent and a recipient agent. In particular, the example signaling diagram of FIG. 9 illustrates transforming communications and authenticating a source agent in the cloud (e.g., at a host system).

As described herein, the host system may first train the source agent's individual voice. The host system generates and stores the transformation files based on the voice training. Alternatively, certain default files or files generated by the system may be provided. The source agent subsequently transfers a communication to the host system. For example, the communication may be a text-based communication.

In the example of FIG. 9, once the communication has been received by the host system, the host system optionally authenticates the source agent, identifies the recipient agent, and determines the recipient communication mode. As discussed above, the host system may determine the recipient communication mode by monitoring the recipient agent and/or based on messaging received from the recipient agent. The host system subsequently accesses transform files associated with the source agent and transforms the communication from the first communication mode to the second communication mode. For example, the host system may transform a text-based communication to a voice-based communication. In this example, the transformed communication (e.g., the voice-based communication) is returned to the source agent where it is transferred to the recipient agent.

The recipient agent provides the voice-based communication to the recipient user. The recipient agent may subsequently receive a voice-based response from the recipient user. The voice-based response can be sent to the source agent where it is forwarded to the host system for transformation from the voice-based communication mode to a text-based communication mode. The transformed response communication is then sent to the source agent where it is provided to the source agent via the text-based communication mode.

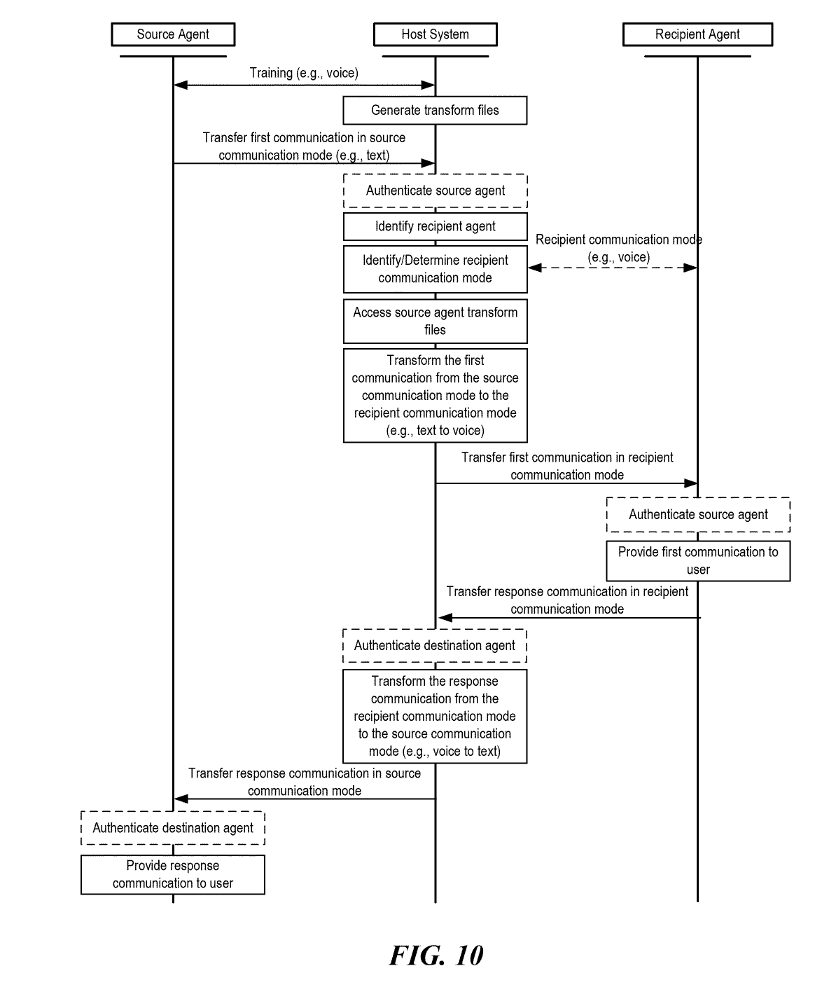

FIG. 10 is a signaling diagram that illustrates representative messaging used by a source agent and a recipient agent to transform communications at a host system. The example of FIG. 10 is similar to the example of FIG. 9, however, in the example of FIG. 10 both the source agent and the recipient agent utilize the host system to perform the authentication and transformation steps required to facilitate the customized and verified multi-mode communication between the agents. Additionally, rather than transforming a communication and sending it back to the agent that sent the communication, the example signaling diagram of FIG. 10 illustrates a host system that directly forward communications to the recipient agents.

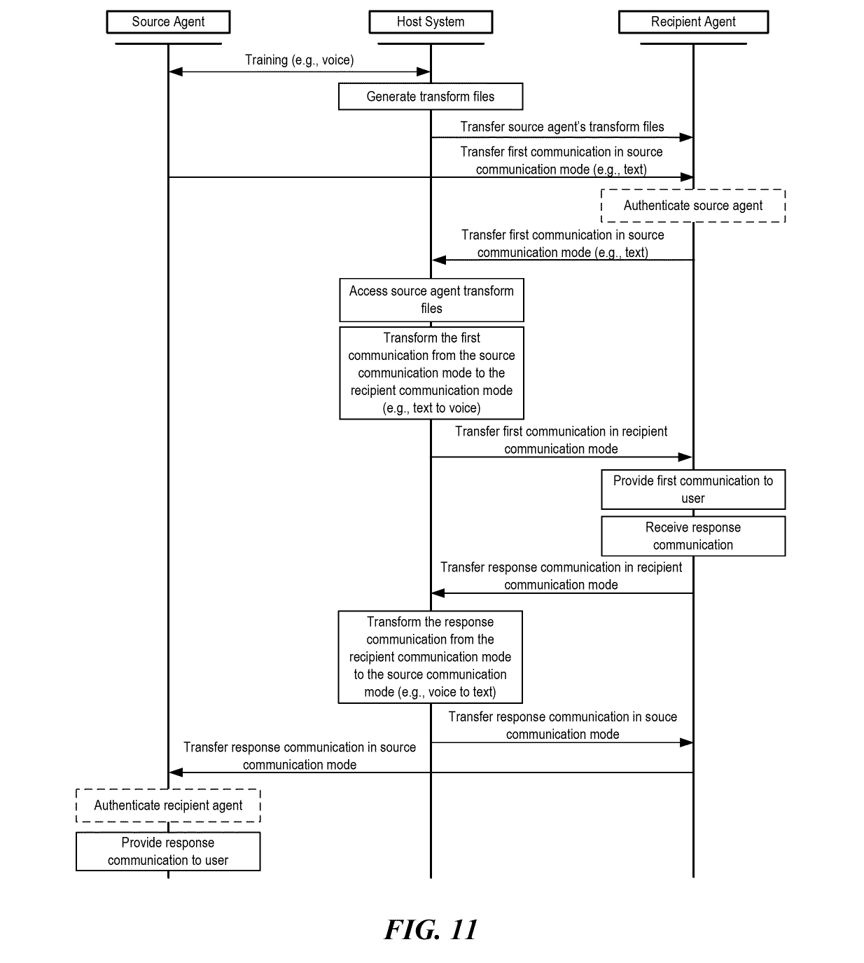

FIG. 11 is a signaling diagram that illustrates representative messaging used by a recipient agent to transform communications at a host system. The example of FIG. 11 is similar to the example of FIG. 9, however, in the example of FIG. 11 the recipient agent utilizes the host system to perform the authentication and transformation steps required to facilitate the customized and verified multi-mode communication between the agents.

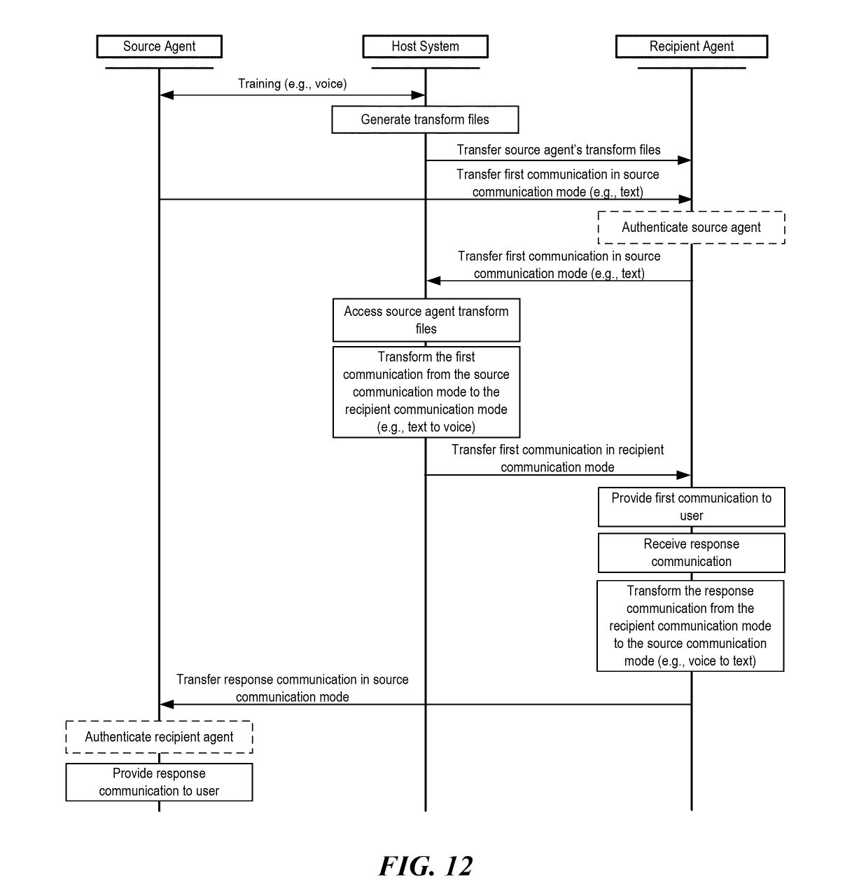

FIG. 12 is a signaling diagram that illustrates representative messaging used by a recipient agent to transform communications at a host system and at the recipient agent. The example of FIG. 12 is similar to the example of FIG. 11, however, in the example of FIG. 12 both the recipient agent and the host system perform the authentication and transformation steps required to facilitate the customized and verified multi-mode communication between the agents. In particular, the host system performs the first transformation of the original communication from the source agent and the recipient agent performs the transformation of the response communication.

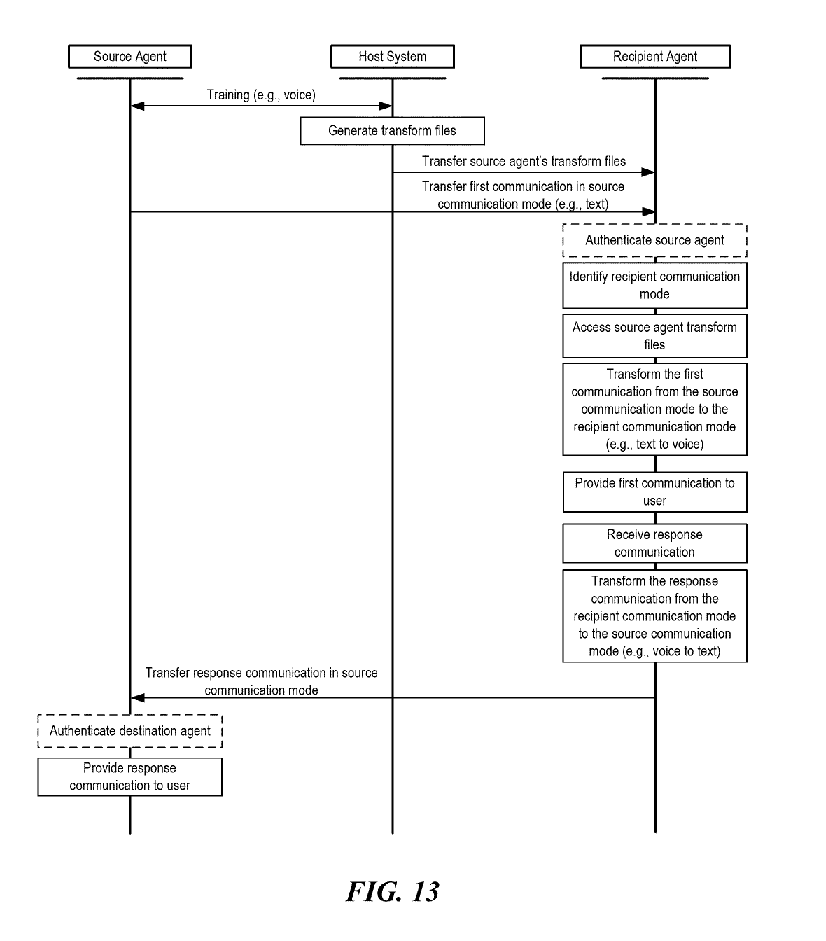

FIG. 13 is a signaling diagram that illustrates representative messaging used by a recipient agent to transform communications at a recipient agent. The example of FIG. 13 is similar to the example of FIG. 12, however, in the example of FIG. 13 the recipient agent performs the transformation steps required to facilitate the customized and verified multi-mode communication between the agents.

FIG. 14 is a signaling diagram that illustrates representative messaging used by a source agent to transform communications at the source agent with transform files downloaded from the host system. The example of FIG. 14 is similar to the example of FIG. 9, however, in the example of FIG. 14 the source agent performs the authentication and transformation steps required to facilitate the customized and verified multi-mode communication between the agents.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times.

The teachings of the invention provided herein can be applied to other systems, not necessarily the system described above. The elements and acts of the various examples described above can be combined to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims

While certain aspects of the invention are presented below in certain claim forms, the applicant contemplates the various aspects of the invention in any number of claim forms. For example, while only one aspect of the invention is recited as a means-plus-function claim under 35 U.S.C sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6.) Accordingly, the applicant reserves the right to add additional claims after filing the application to pursue such additional claim forms for other aspects of the invention.

We claim:

1. A method implemented in a wireless telecommunications network, the method comprising:
receiving, at a wireless telecommunications device, a communication via a communication protocol,
wherein the communication originates from a source agent operating in a text-based communication mode;
authenticating the source agent;
after the source agent is authenticated, processing the communication to identify a recipient agent;
determining, at the wireless telecommunications device, that the recipient agent is operating in a voice-based communication mode;
transforming the communication from the text-based communication mode to the voice-based communication mode when the recipient agent is operating in the voice-based communication mode,
wherein the transforming includes generating a voice file customized based on the recipient agent; and
providing the communication to the recipient agent in the voice-based communication mode via the customized voice file.

2. The method of claim 1, wherein the transforming the communication comprises:
selecting a tone for the communication based on the recipient agent;
selecting one or more paralinguistic events associated with the communication based on one or more of the communication and the source agent; and
generating the voice file for the recipient agent based on one or more of the tone and the one or more paralinguistic events.

3. The method of claim 1, further comprising:
prior to receiving the communication originating from the source agent, training a voice synthesizer to generate a voice associated with a user of the source agent.

4. The method of claim 3, wherein training the voice synthesizer comprises:
interacting with the source agent to generate multiple source agent voice segments, wherein at least some of the voice segments have differing tones and paralinguistic events.

5. The method of claim 1, further comprising:
establishing a communication session between the source agent and the recipient agent, wherein the communication session utilizes the text-based communication mode and the voice-based communication mode.

6. The method of claim 1, wherein the source agent is authenticated using one or more unused fields of the communication protocol.

7. The method of claim 1, wherein the source agent is authenticated based on one or more encryption algorithms.

8. The method of claim 1, wherein the determining that the recipient agent is operating in the voice-based communication mode comprises:
automatically detecting current movement of the recipient agent; and
automatically determining that the recipient agent is operating in the voice-based communication mode based on the current movement of the recipient agent.

9. The method of claim 1, wherein the determining that the recipient agent is operating in the voice-based communication mode comprises:
automatically detecting conditions associated with the recipient agent; and
automatically determining that the recipient agent is operating in the voice-based communication mode based on the conditions.

10. The method of claim 9, wherein the conditions comprise one or more of location of the recipient agent, preferences associated with the recipient agent, environmental conditions associated with the recipient agent, or historical data associated with the recipient.

11. The method of claim 1, wherein the determining that the recipient agent is operating in a voice-based communication mode comprises:
receiving an indication of a mode of operation associated with the recipient agent; and
automatically determining that the recipient agent is operating in the voice-based communication mode based on the indication.

12. The method of claim 1, wherein the transforming the communication comprises:
selecting a tone for the communication based on the recipient agent;
selecting one or more styles associated with the communication based on content of the communication;
selecting one or more paralinguistic events associated with the communication based on the content of the communication;
selecting source agent voice segments based on one or more of the tone and the one or more styles associated with the communication; and
generating the voice file for the recipient agent based on one or more of the selected source agent voice segments and the one or more paralinguistic events.

13. The method of claim 12, wherein the one or more styles are selected based on one or more of the content of the communication and other indicators included within the communication.

14. The method of claim 13, wherein the other indicators comprise emoticons.

15. The method of claim 12, wherein the one or more paralinguistic events are selected based on language usage patterns associated with a user of the source agent.

16. A computer-readable medium storing instructions to be implemented by a communication device configured to communicate with other communication devices in a telecommunications network, wherein the instructions, when executed by a processor, cause the communication device to:
receive a communication via a communication protocol,
wherein the communication originates from a source agent operating in a source communication mode;
authenticate the source agent;
determine a recipient communication mode associated with a recipient agent;
transform the communication from the source communication mode to the recipient communication mode,
wherein to transform the communication, the communication is customized based on the recipient agent; and
provide the communication to the recipient agent in the recipient communication mode.

17. The computer-readable medium of claim 16, wherein the instructions, when executed by the processor, further cause the communication device to:
establish a communication session between the source agent and the recipient agent, wherein the communication session utilizes the source communication mode and the recipient communication mode.

18. The computer-readable medium of claim 16, wherein the instructions, when executed by the processor, further cause the communication device to:
train a voice synthesizer to generate a voice associated with a user of the source agent; and
interact with the source agent to generate multiple source agent voice segments, wherein at least some of the voice segments have differing tones and paralinguistic events.

19. A telecommunications system comprising:
a communication device configured to receive a communication via a communication protocol and provide the communication to a recipient agent in a voice-based communication mode via a customized voice file, wherein the communication originates from a source agent operating in a text-based communication mode; and
a processing device configured to authenticate the source agent, process the communication to identify the recipient agent, determine if the recipient agent is operating in the voice-based communication mode, and transform the communication from the text-based communication mode to the voice-based communication mode if the recipient agent is operating in the voice-based communication mode, wherein to transform the communication, a voice file is generated that is customized based on the recipient agent.

20. A wireless telecommunications device comprising:
means for receiving a communication via a communication protocol,
wherein the communication originates from a source agent in a source communication mode;
means for authenticating the source agent;
means for identifying a recipient agent;
means for determining a recipient communication mode associated with the recipient agent;
means for transforming the communication from the first communication mode to the second communication mode based on the recipient agent; and
means for providing the communication to the recipient agent in the recipient communication mode.
